(19) United States
(12) Patent Application Publication
(10) Pub. No.: US 2018/0370633 A1
(43) Pub. Date: Dec. 27, 2018

(54) LOGISTIC PANEL

(71) Applicants: Jerrell P. Squyres, Point, TX (US); Elizabeth K. Squyres, Point, TX (US)

(72) Inventors: Jerrell P. Squyres, Point, TX (US); Elizabeth K. Squyres, Point, TX (US)

(21) Appl. No.: 15/784,094

(22) Filed: Oct. 14, 2017

Related U.S. Application Data
(60) Provisional application No. 62/525,178, filed on Jun. 26, 2017.

(51) Int. Cl. B64D 9/00; B61D 45/00; B65D 90/00

(52) U.S. Cl. CPC B64D 9/003; B65D 88/54; B65D 90/004; B61D 45/001

(57) ABSTRACT

A novel logistic panel is disclosed. The logistic panel is adapted for use within cargo containers and enables vertical mounting tracks of a cargo beam and decking system to be located at various desired centers, or intervals, along the length of the container wall, even if the locations of the logistic posts do not coinside with the desired locations of the vertical mounting tracks. The logistic panel comprises a plurality of recessed channels for receiving complementary sized vertical mounting tracks. The mounting tracks and the recessed channels of the logistic panel are sized and configured such that the tracks do not substantially project into the interior of the cargo container and to therefore minimize the risk of the mounting tracks being damaged during loading and unloading operations.

### CROSS-REFERENCE TO RELATED APPLICATIONS

This application claims the benefit of U.S. Provisional Application No. 62/525,178, filed on Jun. 26, 2017, the contents of which are incorporated herein by reference.

### TECHNICAL FIELD

The present invention relates generally to the field of cargo containers and more specifically to logistic panels that may form a portion of, or be attached to, the wall of a cargo container.

### BACKGROUND OF THE INVENTION

In freight transportation it is often desirable to stack cargo in multiple levels to take full advantage of the available height of containers such as truck trailers, aircraft, railroad cars, and other similar cargo containers. To facilitate this process it is common practice to employ removable decking beams capable of supporting the weight of heavy payloads. Typically such decking beams are adjustable, allowing them to be repositioned within a cargo container at various heights and horizontal intervals, depending on the size and nature of the cargo.

FIG. 1 illustrates a typical cargo beam and decking system in accordance with the prior art. FIG. 1 is a cut-away perspective view of a truck trailer containing two rows and stacks of cargo pallets. As shown, a series of vertical mounting tracks 10 line the walls along the length of the cargo container. Each of the mounting tracks 10 includes a series of openings for adjusting the height of the decking beams 20. In the present example four decking beams 20 span the width of the trailer, providing support for the top layer of cargo pallets 30.

FIG. 2 is a side view of an adjustable decking beam in accordance with the prior art. The beam 20 comprises a central section 50 that is hollow and two adjustable end pieces 60, 70 that are slidably disposed within the ends of the beam. Each end piece further comprises a “foot” 65, 75 that can be slidably disposed along the vertical mounting tracks 10 shown in FIG. 1. The feet have trigger, locking mechanisms 80 that engage and disengage with the openings in the mounting tracks, thereby allowing the beams to be locked into place at different heights, according to the needs of the user.

FIG. 3 is a cut-away perspective view of a typical cargo beam and decking system in accordance with the prior art but with the cargo pallets removed. As may be seen in FIG. 3, the walls of cargo containers are typically manufactured to comprise vertical logistic posts 90, which provide structural support for the containers. The horizontal spacing, or intervals, between logistic posts 90 may vary depending on a variety of factors including, but not limited to, the manufacturer of the container, the size of the container, and the type of the container. The vertical logistic posts 90, however, are commonly positioned on twenty-four inch intervals along the length of the container wall. Mounting tracks 10 of the prior art are typically part of, or attached to, vertical logistic posts 90. Accordingly, in the prior art, the intervals between mounting tracks 10 are necessarily the same as the intervals between logistic posts 90 along the length of the cargo container wall. In other words, the locations of the logistic posts 90 limit the possible locations of the mounting tracks 10 in the prior art.

It is often desirable to modify the horizontal spacing, or intervals, between mounting tracks 10 by locating them at intervals that are different from the intervals between logistic posts 90. For example, reducing the intervals between mounting tracks 10 allows more decking beams 20 to be positioned along the length of the cargo container, which increases the collective load bearing capacity of the decking beam system. Thus, it may be desirable to locate the mounting tracks 10 at sixteen inch intervals, rather than the twenty-four inch intervals between logistic posts 90. One way of accomplishing this in the prior art was by adding additional logistic posts 90 to the walls of the cargo container, but this approach was associated with significant disadvantages, including increased manufacturing costs, additional weight to the cargo container, and reduced fuel efficiency for vehicles transporting the cargo container. A need therefore exists for providing a relatively lightweight means for inexpensively and efficiently locating vertical mounting tracks (and thus decking beams) within cargo containers at intervals other than the intervals between logistic posts.

### SUMMARY OF THE INVENTION

The present disclosure is directed to various embodiments of a novel logistic panel that enables vertical mounting tracks of a cargo beam and decking system to be located on various desired intervals along the length of the container wall, even if the desired intervals are different from the intervals between logistic posts. For example, if the logistic posts of the wall of the cargo container are located on twenty-four inch intervals, embodiments of the disclosed logistic panel will enable vertical mounting tracks to be located on sixteen inch intervals along the wall of the cargo container. Those skilled in the art, however, will appreciate that the disclosed logistic panel can readily be used to locate mounting tracks at a variety of intervals, and that the invention is not limited to the twenty-four to sixteen inch conversion of the example. Furthermore, embodiments of the disclosed logistic panel may also be used to locate vertical mounting tracks on larger intervals than the intervals between logistic posts.

In a preferred embodiment, the logistic panel is formed from a relatively flat sheet of material and sized to be mounted on the wall of a cargo container between two adjacent logistic posts. Each logistic panel comprises one or more recessed channels that are sized for receiving vertical mounting tracks. Vertical mounting tracks are attached to one or more selected channels of the logistic panel. The mounting tracks are therefore located at positions other than the positions of the logistic posts. Decking beams can therefore be attached to the vertical mounting tracks at positions other than the positions of the logistic posts and at intervals other than the intervals between the logistic posts.

The invention encompasses embodiments of the logistic panel, which can be used to retrofit existing cargo containers, as well as cargo containers that are originally manufactured to comprise embodiments of the logistic panel.

### BRIEF DESCRIPTION OF THE DRAWINGS

The novel features believed characteristic of the invention are set forth in the appended claims. The invention itself, however, as well as a preferred mode of use, further objects and advantages thereof, will best be understood by reference to the following detailed description of illustrative embodiments when read in conjunction with the accompanying drawings, wherein:

FIG. 1 is a cut-away perspective view of a cargo container employing a cargo beam and decking system in accordance with the prior art;

FIG. 2 is a side view of an adjustable decking beam in accordance with the prior art;

FIG. 3 is a cut-away perspective view of a typical cargo beam and decking system in accordance with the prior art but without the presence of cargo pallets;

FIG. 4 is a front view of two logistic panels in accordance with an embodiment of the present invention;

FIG. 4A is a top view of the two logistic panels of FIG. 4;

FIG. 5 is a perspective view of a mounting track attached to a logistic panel in accordance with an embodiment of the present invention;

FIG. 5A is a cut-away view taken along the plane indicated by 5A in FIG. 5 showing a recessed channel;

FIG. 6 is a cut-away perspective view of a cargo container employing logistic panels in accordance with an embodiment of the present invention to anchor adjustable beams; and

FIG. 7 is a more detailed, cut-away perspective view of a portion of a mounting track installed within a channel of a logistic panel.

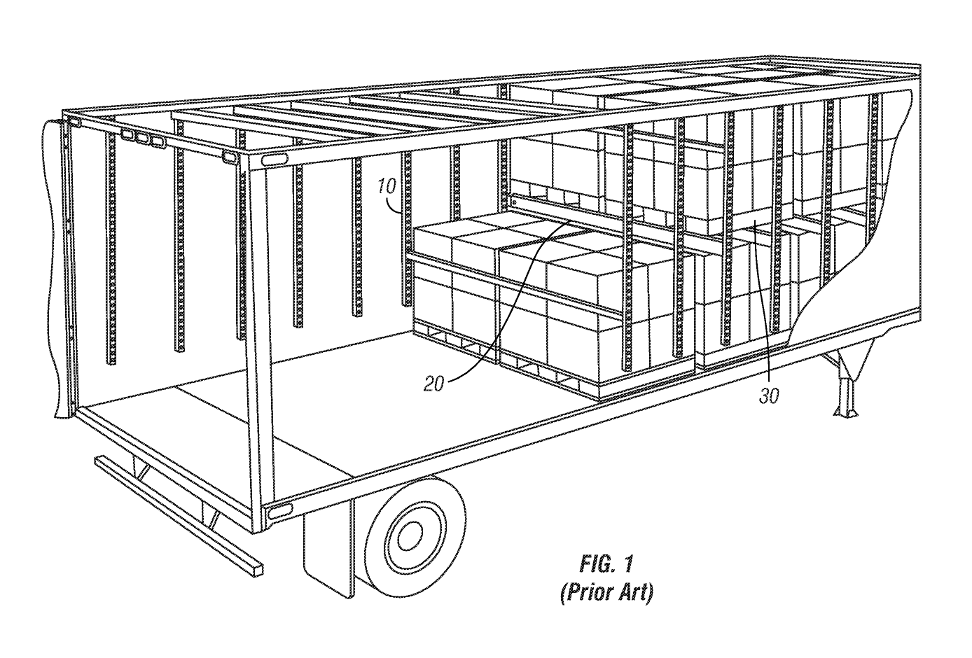

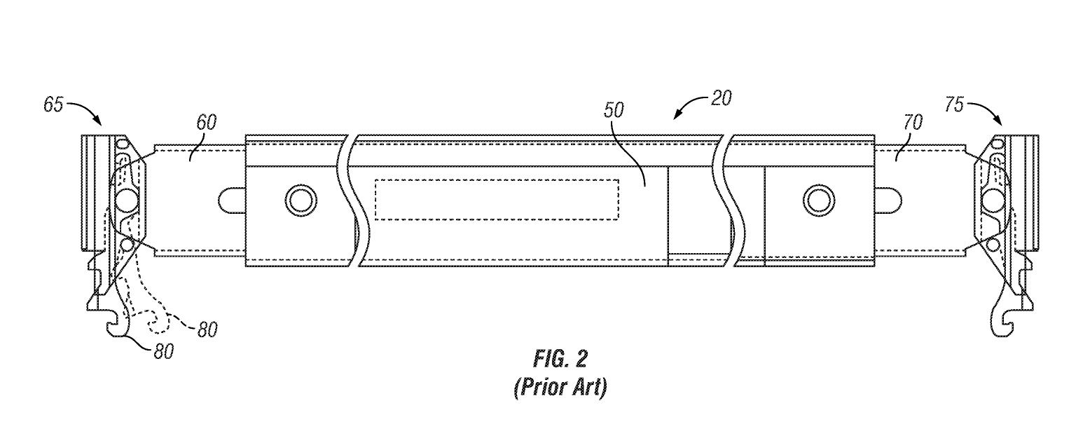

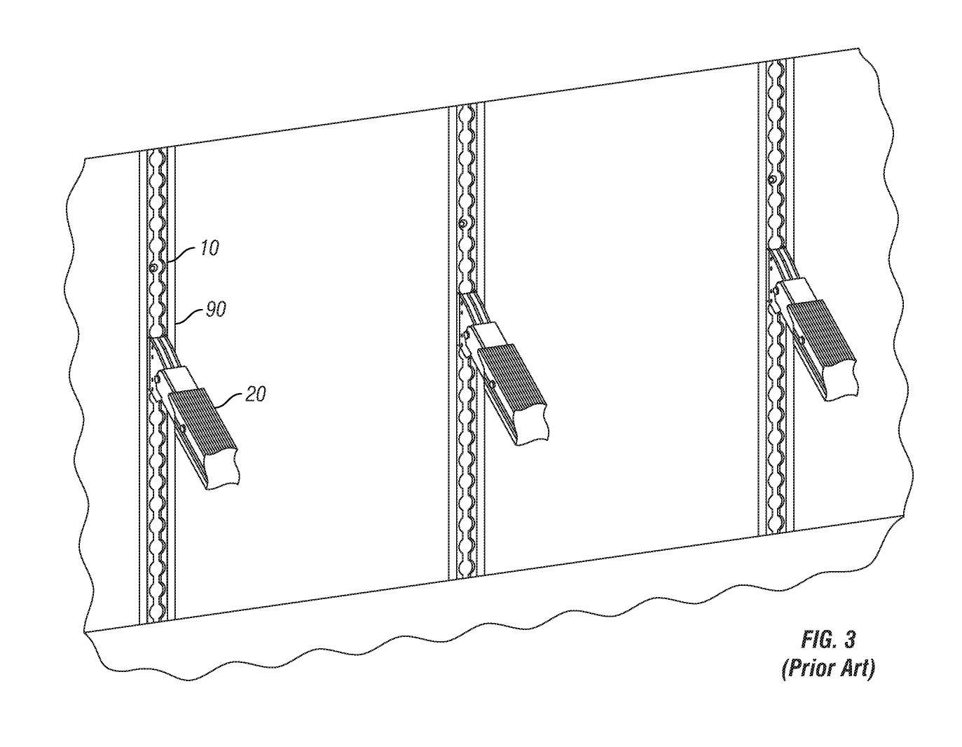

### DETAILED DESCRIPTION

The novel features believed characteristic of the invention are set forth in the appended claims. The invention itself, however, as well as a preferred mode of use, further objects and advantages thereof, will best be understood by reference to the following detailed description of illustrative embodiments when read in conjunction with the accompanying drawings.

A cargo decking beam system with which the novel logistic panel may be used is disclosed in U.S. Pat. Nos. 9,505,337; 9,393,896; 9,333,898; 9,315,143; 9,199,572; 9,180,807; 9,090,192; and 9,090,191; each of which are owned by the assignee of the present disclosure; and each of which is incorporated herein by reference. The logistic panel of the present disclosure preferably works in conjunction with the cargo decking beam system of the foregoing patents by providing a novel way of mounting vertical mounting tracks 10 at intervals that are desirable for use of the cargo decking beam system. The desired intervals may be different from the intervals between the logistic posts of the wall of the cargo container. The cargo container can be a trailer, a shipping container, a railcar, an aircraft, or any other type of container known in the art for shipping cargo. The novel logistic panel of the present disclosure provides also an improved way of installing a cargo decking beam system of the foregoing patents inside a cargo container. However, it should be understood that the presently disclosed logistic panel may be used in connection with other cargo beam and decking systems.

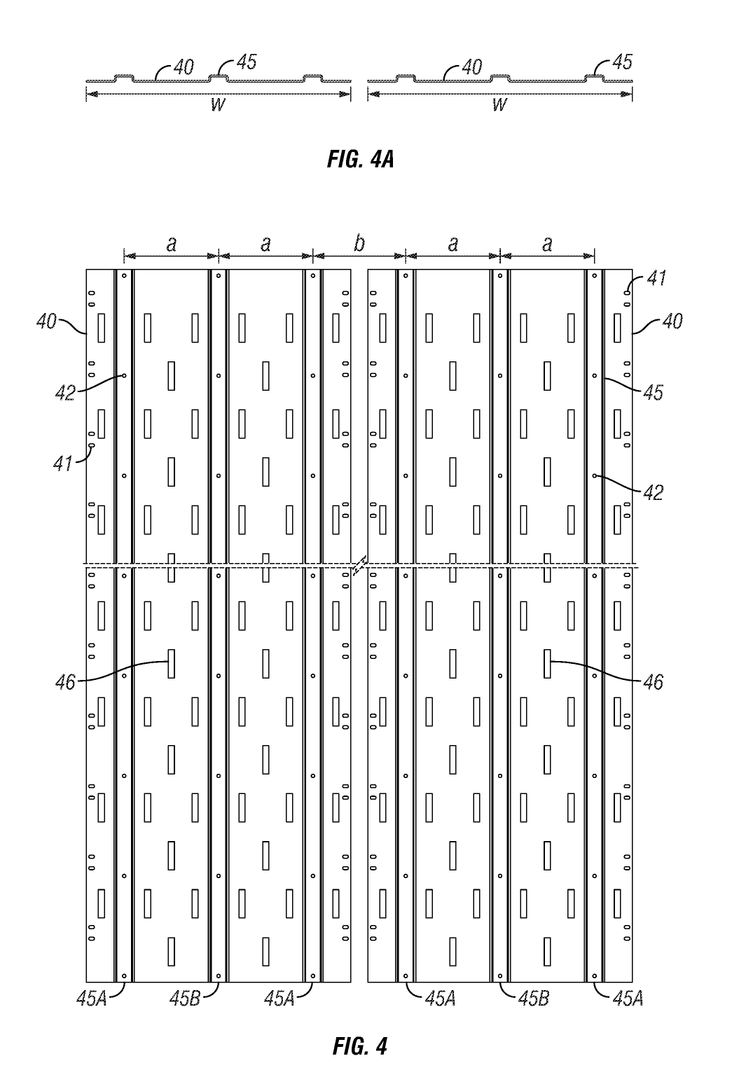

FIG. 4 is a front view of two logistic panels 40 in accordance with an embodiment of the present invention, and FIG. 4A is a top view of the two logistic panels of FIG. 4. Logistic panels 40 are shown in side-by-side in positions similar to those they would occupy if they were attached to adjacent logistic posts 90 (not shown in FIG. 4). Logistic panel 40 of the present disclosure can be a relatively thin panel with a generally rectangular shape, and it can be fabricated from sheet metal through roll forming or press break fabrication operations. In a preferred embodiment, logistic panel 40 can be constructed from twelve or fourteen gauge, steel or aluminum sheet metal. The width w of each logistic panel 40 can be sized such that the logistic panel 40 can be attached to adjacent logistic posts 90 in the wall of the cargo container. The length of each logistic panel 40 can be sized such that the logistic panel 40 extends from substantially the top of the inner wall of a cargo container to near the bottom of the inner wall of the cargo container. In a preferred embodiment, logistic panel 40 comprises a plurality of apertures 41 located along the outer, longitudinal edges of logistic panel 40 that can be used for attaching logistic panel 40 to the logistic posts 90 of the cargo container. Apertures 41 can be located along the outer edges of each logistic panel 40 to facilitate attachment of logistic panel 40 to the logistic posts 90. Fasteners, such as bolts, screws, rivets and other kinds of fasteners known in the art can be used to attach logistic panel 40 to logistic posts 90. Using fasteners to attach logistic panel 40 to logistic posts 90 permits the logistic panel 40 to be quickly and easily removed and replaced with another logistic panel 40 in the event of damage. Alternatively, logistic panel 40 can be attached to logistic posts 90 by the use of adhesives or welding, as known in the art.

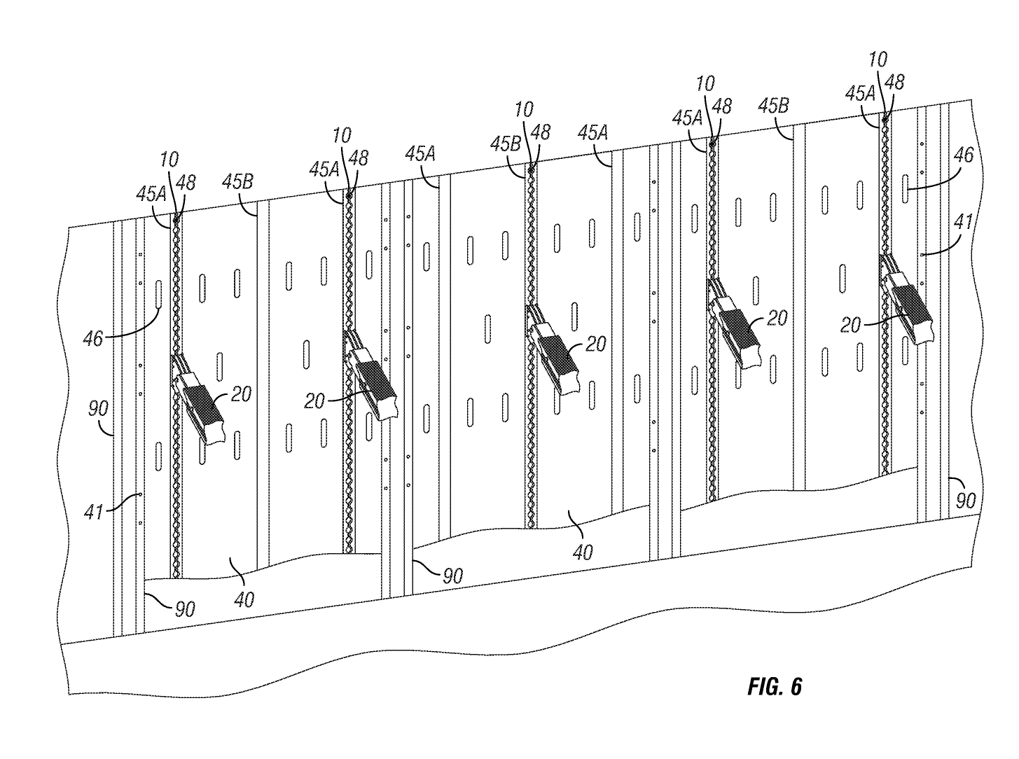

One or more recessed channels 45 can be formed in logistic panel 40 during fabrication for receiving a complementary-sized vertical mounting track 10. Recessed channels 45 extend along at least a portion of the length of logistic panel 40. In a prefered embodiment, each logistic panel 40 preferably comprises three channels 45, with each channel being about one to two inches wide and about half an inch deep, but the present invention is not limited to three channels of these preferred dimensions, and other numbers of channels with larger or smaller dimensions are within scope of the invention. Channels 45 can be general parallel to each other. As explained in more detail in connection with FIG. 6, the number and intervals between channels 45 in logistic panel 40 can be used to vary the intervals between vertical mounting tracks 10 (and thus the intervals between decking beams 20).

In a preferred embodiment, each logistic panel 40 has two outer channels 45A and one inner channel 45B. Channels 45 are formed in logistic panel 40 such that the centerlines of channels 45 are located a first distance a from each other, as shown in FIG. 4. In other words, the interval between channels 45 is the first distance a. When two logistic panels 40 are positioned side-by-side for mounting to a logistic post 90, adjacent outer channels 45A of the two logistic panels 40 are located a second distance b from each other, as also shown in FIG. 4.

In a preferred embodiment, the width w of each logistic panel 40 is approximately 22.5 inches so that each logistic panel 40 can be attached to logistic posts 90 located on approximately twenty-four inch centers, or intervals, and channels 45 of logistic panel 40 are located and spaced such that first distance a and second distance b are each approximately eight inches. As described in more detail in connection with FIG. 6 below, this configuration will permit vertical mounting tracks 10 to be positioned on sixteen inch intervals by attaching vertical mounting tracks 10 to outer channels 45A in one logistic panel 40 and attaching another vertical mounting track 10 to inner channel 45B in the adjacent logistic panel 40, and continuing this alternating pattern along the length of the wall of the cargo container. In addition, the width w of a logistic panel 40 can be significantly less than 22.5 inches to accommodate reduced spacing between logistic posts 90 at the end of a cargo container, for example. While these dimensions are described as a preferred embodiment, persons skilled in the art will readily understand that the present invention is not limited to the particular dimensions described and can readily be implemented with numerous other dimensions.

In further reference to FIG. 4, logistic panel 40 may also comprise one or more mounting apertures 46 for attaching additional components and structures to logistic panel 40. Mounting apertures 46 can be A-slots or E-slots, as known in the art, or can be any other kind of aperture that may be useful for the particular purpose desired.

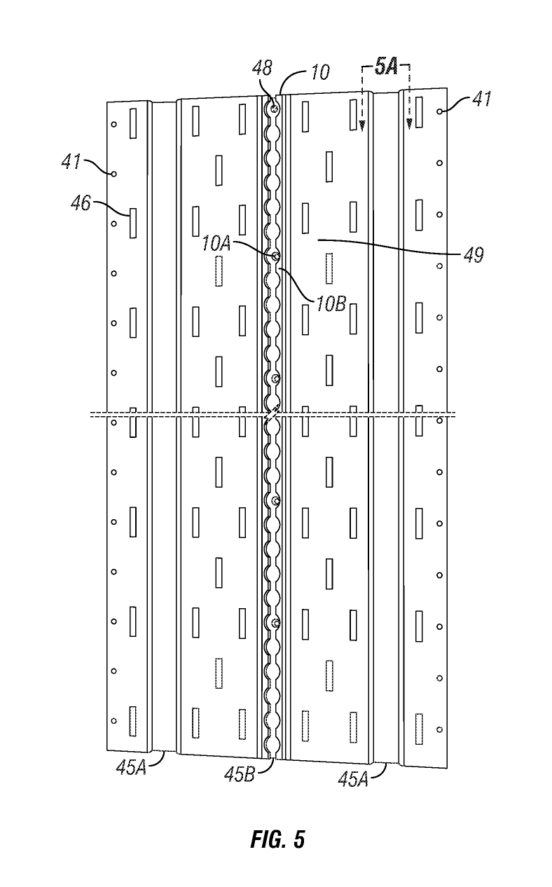

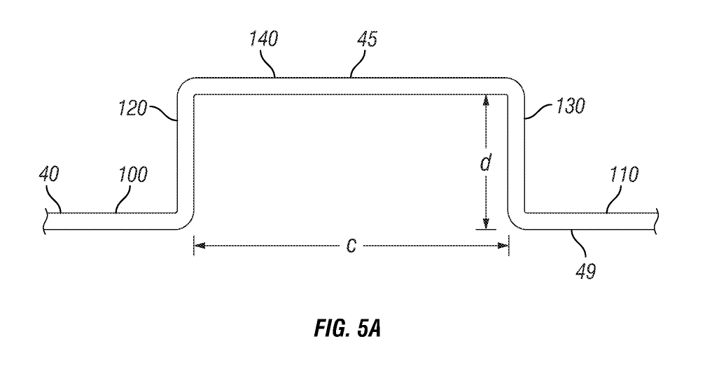

FIG. 5 is a perspective view of a mounting track 10 attached to a logistic panel 40 in accordance with an embodiment of the present invention. Vertical mounting track 10 is shown positioned within inner channel 45B in this embodiment, but it should be understood that mounting tracks 10 can be positioned within outer channels 45A as well. Vertical mounting track 10 may be formed with one or more apertures 10A along its length to facilitate attachment of vertical mounting track 10 to logistic panel 40. Fasteners of various types can be used to attach vertical mounting track 10 to logistic panel 40, including but not limited to bolts, screws, and rivets and other kinds of fasteners known in the art. Using fasteners to attach mounting track 10 to logistic panel 40 permits the mounting track 10 to be quickly and easily removed and replaced with another mounting track 10 in the event of damage. Alternatively, mounting track 10 can be attached to logistic panel 40 using adhesives, crimping, or welding techniques known in the art.

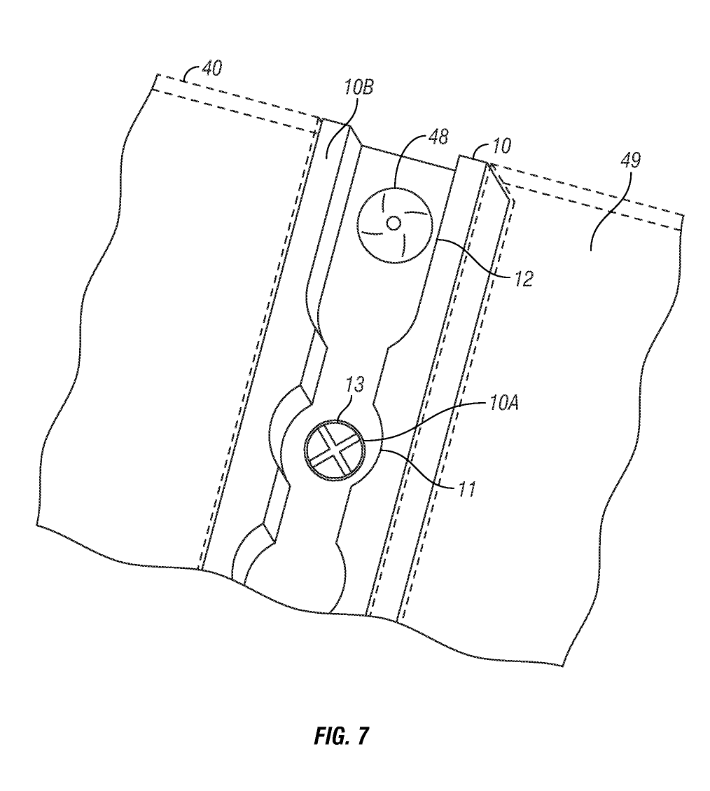

The depth of each channel 45 is preferably sized such that, when vertical mounting track 10 is positioned within channel 45, the inner surface 10B of vertical mounting track 10 is approximately flush with (i.e., occupies approximately the same plane as) the inner surface 49 of logistic panel 40 (see also FIGS. 5A and 7). Surfaces 10B and 49 are referred to as “inner” because they face the interior of the cargo container when the logistic panel 40 (with mounting track 10) is installed to the wall of the cargo container between two adjacent logistic posts 90. Therefore, each channel 45 is sized such that surface 10B of mounting track 10, when mounted within channel 45, does not extend or project significantly past surface 49 toward the interior of the cargo container when vertical mounting track 10 is attached within channel 45 and the panel 40 is mounted to logistic posts 90 within the cargo container. This configuration tends to reduce the risk of mounting tracks 10 and/or logistic panel 40 being damaged during loading and unloading operations by a forklift, for example.

FIG. 5A is a cut-away view taken along the plane indicated by 5A in FIG. 5 showing a recessed channel 45. Channel 45 can be formed between first planar portion 100 and second planar portion 110. First flange portion 120 extends laterally from first planar portion 100, and second flange portion 130 extends laterally from second planar portion 110. First flange portion 120 and second flange portion 130 extend in a direction away from inner surface 49 of logistic panel 40. While first flange portion 120 and second flange portion 130 are shown as being approximately perpendicular to first planar portion 100 and second planar portion 110, respectively, in FIG. 5A, either or both of first flange portion 120 and second flange portion 130 could extend at either acute or oblique angles with respect first planar portion 100 and second planar portion 110.

Web 140 extends between first flange portion 120 and second flange portion 130 to form channel 45. Web 140 can occupy a plane that is generally parallel to the plane occupied by first planar portion 100 and second planar portion 110. Thus, channel 45 has a width c and a depth d to accommodate vertical mounting track 10. As previously noted, in a preferred embodiment, the width c is generally between one and two inches, and the depth d is generally about one half inch, but the present invention is not limited to these preferred dimensions, and channels with larger or smaller dimensions are within scope of the invention.

FIG. 6 is a cut-away perspective view of a cargo container employing logistic panels 40 in accordance with an embodiment of the present invention to anchor adjustable beams. Logistic panels 40 are positioned in a side-by-side configuration along the wall of the cargo container and attached to adjacent logistic posts 90 with fasteners through apertures 41. As noted above, the fasteners can be bolts, screws, rivets, or any other suitable fastener known in the art. A mounting track 10 is attached within inner channel 45B of a first logistic panel, and two other mounting tracks 10 are attached within outer channels 45A of a second, adjacent logistic panel. A decking beam 20 is attached to each of the mounting tracks 10.

Thus, the utilization of logistic panels 20 and mounting tracks 10 permits multiple decking beams 20 to be mounted at a variety of locations along the length of the cargo container. With the use of logistic panel 40, the locations of logistic posts 90 do not limit or dictate the possible number or locations of decking beams 20, as with systems of the prior art. FIG. 6 shows that logistic posts 90 are positioned at a first interval, and mounting tracks 10 are positioned at a second interval.

It will be apparent to those skilled in the art that, depending on the particular configuration used, the second interval between mounting tracks 10 can be either longer or shorter than the first interval between logistic posts 90. For example, when the logistic posts 90 of a cargo container are located on twenty-four inch intervals, first distance a and second distance b can be sized to be approximately eight inches (see FIGS. 4 and 4A). By attaching mounting tracks 10 to logistic panel 40 in the alternating pattern shown in FIG. 6, logistic panel 40 permits decking beams to be mounted at approximately sixteen inch intervals along the length of the cargo container, thereby increasing the load carrying capacity of the decking beam system. FIG. 7 is a more detailed, cut-away perspective view of a portion of a mounting track 10 installed within a channel 45 of a logistic panel 40. Fastener 13 can be used with aperture 10A to attach mounting track 10 to logistic panel 40. Aperture 10A is countersunk so that the head of fastener 13 does not project into the path of the foot of a decking beam 20 as it moves vertically within the track.

As shown best in FIGS. 5, 6 and 7, each vertical mounting track 10 may additionally comprise a permanent, integral beam stop 48 located near the top of the track. In a preferred embodiment, beam stop 48 comprises a fastener, such as a bolt or rivet, that can extend through the top of vertical mounting track 10. The integral beam stop 48 further comprises an enlarged head portion that projects into the path of the foot of the decking beam 20 as it moves vertically within the mounting track 10. The head portion thus stops the foot of the decking beam 20 from moving too far in the vertical direction, which can cause damage to the cargo and decking beam system as well as to the cargo container itself. Track 10 is formed with an open portion 12 near the top of the track. Open portion 12 can be formed, for example, by milling away portions of the track during the manufacturing process, but those skilled in the art will appreciate that other ways for forming open portion 12 are known in the art. Open portion 12 provides space for positioning a tool, such as the head of a rivet gun, for attaching integral beam stop 48 to mounting track 10.

While permanent, integral beam stop 48 is a fastener in the preferred embodiment, persons skilled in the art will understand that beam stop 48 can be implemented by a variety of means and can even be formed as part of the track itself, so long as the beam stop means is integrally connected to the track and stops the foot of the decking beam 20 from moving too far in the vertical direction.

In an alternative embodiment, logistic panel 40 can have a reduced width w and only two, rather than three, channels 45. A logistic panel of this alternative embodiment can be used at the end of a cargo container where, due to the particular length of the cargo container, there is a reduced spacing, or interval, between the last two logistic posts 90. For example, in this alternative embodiment, the width w of logistic panel 40 can be approximately 14.5 inches, and the two channels 45 can be located about eight inches from each other. Mounting tracks 10 can be located within each of the channels 45. By attaching logistic panels 40 of this alternative embodiment to the last two logistic posts 90 in a cargo container, and attaching a decking beam 20 to one of the two mounting tracks 10, it is possible to maintain a sixteen inch interval between adjacent decking beams throughout the entire length of the cargo container.

Thus, it will be understood that logistic panel 40 enables a cargo beam and decking system with vertical mounting tracks 10 located on, for example, sixteen inch centers to be positioned and utilized in a cargo container that has vertical logistic posts 90 located on, for example, twenty-four inch centers. Locating vertical mounting tracks 10 on narrower centers permits the decking beams 20 to be located on narrower centers, which increases the collective weight bearing capacity of the decking beam system, and permits more cargo to be loaded onto, and carried by, the decking beam system.

The novel design of logistic panel 40 permits cargo and decking beam systems with vertical mounting tracks 10 on sixteen inch centers to be used in cargo containers that are constructed with logistic posts 90 on twenty-four inch centers without the need to modify the design of the cargo container to add additional logistic posts 90. This results in a substantial weight savings for the cargo container, as compared to a cargo container that is constructed with logistic posts on sixteen inch centers.

In addition, logistic panel 40 can be configured to permit the mounting of adjustable decking beams 20 on eight inch centers to further increase the load bearing capacity of the decking beam system. This can easily be accomplished by merely attaching a mounting track 10 within each channel 45 of each logistic panel 40 and attaching an adjustable decking beam 20 to each track 10. This configuration, because it provides decking beams 20 at approximately every eight inches along the length of the cargo container, further increases the load bearing capacity of the decking beam system as compared to other configurations with decking beams located on twenty-four inch or sixteen inch centers.

Further, because vertical mounting tracks 10 are positioned within channels 45 of logistic panel 40 such that the inner surface 10B is approximately flush with the inner surface 49 of logistic panel 40, the risk of the vertical mounting tracks 10 being damaged during loading and unloading operations, by forklifts for example, is significantly reduced or eliminated.

Moreover, even in the unlikely event that a forklift, for example, happens to hit a vertical mounting track 10, the resulting damage would likely be limited to the particular track 10 and particular logistic panel 40 that were hit; there would likely be little or no damage to the logistic posts or the other tracks and logistic panels. Such damage could easily and inexpensively be repaired by replacing the damaged track 10 and logistic panel 40, if necessary. There would be little or no need to replace the logistic posts or any other tracks or logistic panels.

Logistic panel 40 can be mounted in virtually any cargo container. While a preferred embodiment that converts a cargo container with logistic posts on twenty-four inch centers to contain vertical mounting tracks 10 on sixteen inch centers is described herein, it will be understood by those of skill in the art that logistic panel 40 can adapt a variety of different logistic post spacings, or intervals, to accommodate a variety of different mounting track 10 intervals, merely by varying the dimensions of logistic panel 40 and the number and spacing of channels 45.

The novel design of logistic panel 40, with each panel comprising three channels 45, means that only one panel design needs to be fabricated, regardless of whether a given panel will hold one mounting track 10 in inner channel 45B or two tracks 10 in outer channels 45A.

Logistic panels 40 can be supplied to original equipment manufactures, such as the manufactures of cargo containers, with mounting racks 10 preinstalled and including a beam stop 48 at the top of each track. Thus, a fleet of cargo containers with logistic posts on twenty-four inch centers, for example, can quickly and easily be converted to utilize cargo beam and decking systems having vertical mounting tracks 10 on, for example, sixteen inch centers.

The description of the present invention has been presented for purposes of illustration and description, and is not intended to be exhaustive or to limit the invention to the particular form described. Many modifications and variations will be apparent to those of ordinary skill in the art. The embodiments were chosen and described in order to best explain the principles of the invention, the practical application, and to enable others of ordinary skill in the art to readily make and use the invention. It will be understood by those of ordinary skill in the art that numerous variations of the described embodiments are possible without going outside the scope of the invention as defined in the claims.

1. A logistic panel for mounting adjustable decking beams in a cargo container, the logistic panel comprising:
(a) a panel having a length, a width, and an inner surface, the width of the panel being adapted to extend between adjacent logistic posts on the inner wall of a cargo container;
(b) the panel having a recessed channel extending along at least a portion of the length of the panel;
(c) a vertical mounting track having at least one end, the vertical mounting track being attached within the recessed channel and having an inner surface, the inner surface of the vertical mounting track being generally flush with the inner surface of the panel; and
(d) a beam stop integrally connected to the vertical mounting track and positioned adjacent the at least one end of the vertical mounting track.

2. The logistic panel of claim 1, further comprising a second recessed channel extending along at least a portion of the length of the panel.

3. The logistic panel of claim 2, further comprising a second vertical mounting track having at least one end, the second vertical mounting track being attached within the second recessed channel and having an inner surface.

4. The logistic panel of claim 3, wherein the inner surface of the second vertical mounting track is generally flush with the inner surface of the panel.

5. The logistic panel of claim 4, further comprising a beam stop integrally connected to the second vertical mounting track and positioned near the at least one end of the second vertical mounting track.

6. (canceled)

7. (canceled)

8. (canceled)

9. (canceled)

10. (canceled)

11. (canceled)

12. (canceled)

13. (canceled)

14. (canceled)

15. (canceled)

16. (canceled)

17. (canceled)

18. (canceled)

19. (canceled)

20. (canceled)

21. (canceled)
